(19) United States
(12) Patent Application Publication
(10) Pub. No.: US 2006/0075411 A1
(43) Pub. Date: Apr. 6, 2006

(54) Structure of removable storage media player

(76) Inventor: Ming-Hsiang Yeh, Taipei City (TW)

Correspondence Address: TROXELL LAW OFFICE PLLC, SUITE 1404, 5205 LEESBURG PIKE, FALLS CHURCH, VA, 22041, US

(21) Appl. No.: 10/950,534

(22) Filed: Sep. 28, 2004

(51) Int. Cl. G11B 33/02

(52) U.S. Cl. 720/600

(57) ABSTRACT

An improved structure of a removable storage media player is disclosed. A power source switch, a USB connector, several control buttons, an earphone socket, a microphone, a camera lens, and a connection part are mounted on the outside of the removable storage media (mobile disk). A central processor, an analog/digital converter, a digital signal processor, and a transmission interface are mounted on the inside of the removable storage media. The removable storage media is connected to a key ring through the connection part such that the removable storage media player becomes a decoration with the key ring.

### BACKGROUND OF THE INVENTION

The present invention relates to an improved structure of a removable storage media player, and more particularly to a structure that is suitable for a decoration with a key ring or the like.

Key rings are general articles for daily use and have multifarious categories, most of which are in the form of beautiful, cute, vivid, and amused animal, cartoon personage, or landscape. The most important function of the key ring is to string keys such that the user can recognize and use them easily. The problem of illumination is taken into account by a new style of key ring. Thus, a LED light can be utilized to light up the LED and to help the user to find out the keyhole by merely pushing a button mounted on the LED light, which is mounted on the decorative key ring, if it is hard to find out a keyhole in the dark.

With the progress of the technology, the present portable digital apparatus includes multifarious categories, for example, mobile phone, personal digital assistant, digital camera, notebook computer, multifunctional and removable storage media player. It is very complicated to carry all of them even through they are portable. The easiness of losing them because of rush is their main deficiency.

Whereas the aforementioned deficiencies of the conventional structures which are needed to be improved, the motive of the present invention is to provide a removable storage media player with integrated functions. Accordingly, the present inventor has been made diligent studies with a quiet mind to design and fabricate an improved structure of a removable storage media player and to provide thereof for the consumer.

### SUMMARY OF THE INVENTION

The main purpose of the present invention is to provide an improved structure of a removable storage media player such that the key ring can be applied to listen to music and take picture at the same time.

Another purpose of the present invention is to provide an improved structure of a removable storage media player, wherein memory capacity of a Read Only Memory (ROM) of the removable storage media can be expanded so as to backup important information, for example, maintenance phone numbers, notes for operation, and use data for emergency, by burning them into the ROM.

It is still another purpose of the present invention to apply an improved structure of a removable storage media player to the entrance guard.

According to the aforementioned purposes of the present invention, removable storage media is provided, wherein a power source switch, a USB connector, several control buttons, an earphone socket, a microphone, a camera lens and a connection part are mounted on the outside of the removable storage media (mobile disk). A central processor, an analog/digital converter, a digital signal processor, and a transmission interface are mounted on the inside of the removable storage media. The removable storage media is connected to a key ring through the connection part such that the removable storage media player becomes a decoration with the key ring, namely, the key mounted thereon is provided with the beautiful decoration, and decoration can be used for listening to music or taking picture.

The aforementioned aspects and advantages of the present invention will be readily clarified in the hereafter description of examples of preferred embodiments of the present invention in reference with the enclosed drawings.

### BRIEF DESCRIPTION OF THE DRAWINGS

FIG. 1 is a perspective view showing an outward appearance diagram of a preferred embodiment in accordance with the present invention.

FIG. 2 is a process block diagram of the removable storage media player of the present invention.

FIG. 3 is schematic diagram showing the use of the preferred embodiment of the present invention.

### DETAILED DESCRIPTION OF THE PREFERRED EMBODIMENT

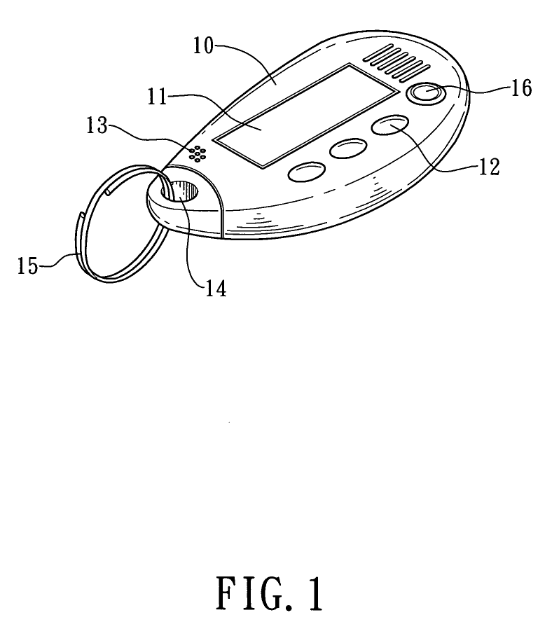

As shown in FIG. 1, an improved structure of a removable storage media player in accordance with the present invention comprises removable storage media 10. A LCD monitor 11, several function buttons 12, a microphone 13, a connection part 14, a camera lens 16, a USB connector (not shown), an earphone socket (not shown), and a battery chamber (not shown) are mounted on the outside of the removable storage media 10. The connection part 14 is coupled to a key ring 15 for roping keys therein such that the removable storage media 10 becomes a decoration with key ring.

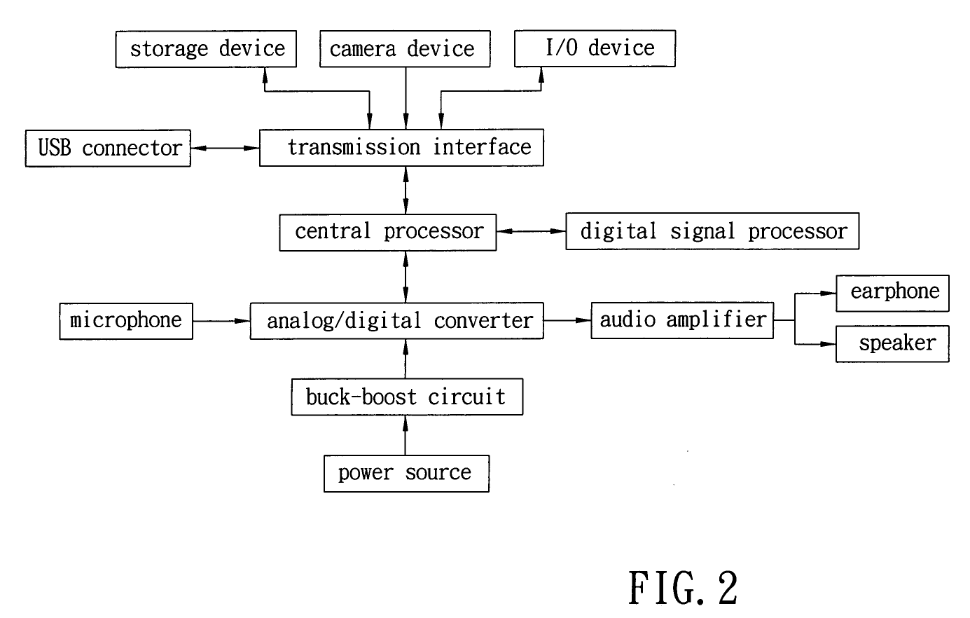

FIG. 2 is a block diagram of internal process of the present invention. Referring to FIG. 2, the USB connector is connected to a transmission interface, which is bi-directionally connected to the central processor. The transmission interface is also bi-directionally connected to a storage device, a camera device, and an output/input device. The central processor is bi-directionally connected to a digital signal processor and an analog/digital converter. The sound inputted from the microphone is guided to the analog/digital converter and then to the earphone and a speaker through an audio amplifier. The analog/digital converter is connected to a power source through a buck-boost circuit.

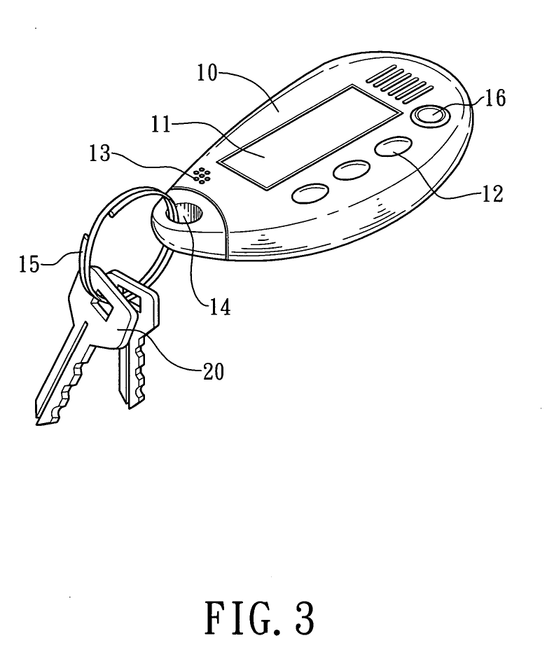

Referring to FIG. 3, the keys 20 are roped in the key ring 15 such that the removable storage media 10 becomes a decoration with the key ring 15. In addition, an earphone can be plugged into the earphone socket on the decoration to listen to the stored music. Moreover, the picture can be taken by means of the camera lens 16. Accordingly, the key ring is integrated with the removable storage media player such that one article has two kinds of functions.

Furthermore, the removable storage media may comprise a built-in Radio Frequency Identification (RFID) System, which is composed of a transponder and a reader. The transponder is a passive answer device. When the system is enabled, the wireless signal with a predetermined frequency will be generated by the reader to active the program embedded in an internal chip of the transponder so as to further generate a radio frequency wave, the ID Code in a memory is transmitted back to the reader and then decoded for differentiation by a master control computer so as to complete the function of identifying the identity. Thus, it is only needed to input data of an individual person or a product into a microchip, and the identifying step can be accomplished by way of the reader. This person or product can pass through entrance guards without carrying various entrance guards' cards.

It is apparent that the apparatus of the present invention comprises the following advantages:

1. The key ring and the removable storage media player can be integrated effectively such that it is only needed to carry one article for achieving the purposes of unlocking, listening to music and taking picture simultaneously.

2. The removable storage media comprises the built-in RFID system applied to the entrance guard for identifying the identity. Thus, the user can pass through the entrance gaud without carrying various entrance guards' cards.

The foregoing preferred embodiments of the present invention are illustrated of the present invention rather than limiting of the present invention. It is intended that various modifications and similar arrangements be included within the spirit and scope of the appended claims.

As described above, the present invention discloses an innovative and improved structure of a removable storage media player. The improved structure of the removable storage media player complies with novelty, non-obviousness, and utility requirements, and is therefore submitted for a patent application.

What the invention claimed is:

1. An improved structure of a removable storage media player comprising:
removable storage media, wherein a power source switch, a USB connector, a plurality of control buttons, an earphone socket, a microphone, a camera lens, and a connection part are mounted on the outside of the removable storage media, and a central processor, a digital/analog converter, a digital signal processor, and a transmission interface are mounted on the inside of the removable storage media, and the removable storage media is coupled to a key ring through the connection part.

2. The improved structure of a removable storage media player of claim 1, wherein the removable storage media comprises a built-in Radio Frequency Identification (RFID) System.
